(19) United States
(12) Patent Application Publication
(10) Pub. No.: US 2011/0285695 A1
(43) Pub. Date: Nov. 24, 2011

(54) Pictorial Representation in Virtual Endoscopy

(76) Inventor: Georg-Friedemann Rust, Gauting (DE)

(21) Appl. No.: 12/921,233

(22) PCT Filed: Mar. 9, 2009
(86) PCT No.: PCT/EP09/01678

§ 371 Date: Dec. 7, 2010

(30) Foreign Application Priority Data
Mar. 7, 2008 (EP) PCT/EP2008/001846

(51) Int. Cl. G06T 15/00

(52) U.S. Cl. 345/419

(57) ABSTRACT

The invention relates to a method for the pictorial representation of a three-dimensional measured data record representing part of a hollow body, comprising the following steps: processing of a first subset of the two-dimensional and/or three-dimensional measured data record for an image reproduction in a first two-dimensional and/or three-dimensional intraluminal pictorial representation of an inner surface of the part of the hollow body, processing of a second subset of the three-dimensional measured data record for an image reproduction in a second two-dimensional and/or three-dimensional intraluminal pictorial representation of the part of the hollow body, representation of the processed first subset of the three-dimensional measured data record in the form of the first two-dimensional and/or three-dimensional intraluminal pictorial representation in a representation plane and representation of the processed second subset of three-dimensional measured data record in the form of the second two-dimensional and/or three-dimensional intraluminal pictorial representation in the representation plane. data of the second subset of the three-dimensional measured data record for one or several planes in a predetermined distance perpendicular to the surface structure represented in the first two-dimensional and/or three-dimensional intraluminal pictorial representation are represented color-coded on the surface structure of the inside of the hollow body which is represented in the entire first two-dimensional and/or three-dimensional intraluminal pictorial representation.

The invention relates to a method for pictorial representation of a three-dimensional measurement data record obtained by means of X-ray photography, radiograms or nuclear spin tomography pictures. The invention relates in particular to a device and method for virtual endoscopy such as particularly virtual coloscopy or bronchoscopy.

### BACKGROUND OF THE INVENTION

Pictorial representation of three-dimensional measurement data is a general important task of computer aided data analysis and preparation. Imaging methods are increasingly important, in particular in the medical diagnostic field. X-ray, radiograms, nuclear spin tomography pictures can be evaluated for diagnostic purposes.

One example of use relates to computer-aided bronchoscopy. A further major application field is the endoscopy of the colon, the so-called coloscopy, which is conventionally realized with an endoscope especially developed for this purpose, the coloscope. Such a coloscope comprises an optical system which usually is connected to a screen to enable the diagnosis of an internist. Introduction of the coloscope into the intestinal area is perceived as unpleasant or even painful by many patients, and there always is a risk, in particular in case of inflammations of the intestinal wall, that the intestinal wall is pierced by the coloscope.

Virtual coloscopy has therefore been developed as an alternative, where no physical coloscope has to be introduced in the body of the patient. Instead, in place of coloscopes, computer tomography/nuclear spin tomography methods and appliances are used to record measured data and visualize the latter on computers. Development of virtual coloscopy has been significantly supported by the fact that implementation of complex image processing methods has nowadays become problem-free, thanks to the high computing power of modern computers.

For virtual coloscopy, a high number of parallel sections is recorded spatially resolved, for instance with a tomography means. One record of two-dimensional image data corresponds to each of these sections. These records are converted into a three-dimensional measured data record with the assistance of a computer. From the three-dimensional measured data record, two-dimensional image data can in turn be calculated, which are independent of the orientation of the section during the actual measurement, for instance obliquelely thereto. As a rule, the two- and three-dimensional image data are reproduced on two-dimensional reproduction means (monitor, photograph, etc.), as tomograms (i.e. all image matrix dots emanate from one intersecting plane) or as quasi three-dimensional images which impart a spatial impression in a manner similar to that of a conventional photograph (imaged matrix dots do not all emanate from one and the same plane).

For instance, US 2005/0018888 describes a method of visualization of superficial texture of the wall of a hollow organ based on a three-dimensional scan of the hollow body.

It should be noted in this context that a priori no deceisions can be taken as to which of the views is best suited for a diagnosis as significant as possible. Although the spatial (quasi three-dimensional) representations are highly descriptive thanks to the imparted spatial impression and are thereby of assistance for orientation, just in these representations, diagnostic findings, such as lesions etc., can be hidden by tissue (e.g. a fold in the intestine) and therefore not be visible. Especially in the present state of the art, the internist in charge of diagnosis will only proceed to further virtual sections and diagnosis procedures if the conventional three-dimensional representation has revealed visible suspicious features. This is to the disadvantage of reliability of virtual endoscopy in a manner that is almost unacceptable for the health of the patients.

Therefore, the task of the present invention is to provide a method and system for virtual endoscopy which are exempt from the depicted drawbacks of virtual endoscopy and which allow a simple and intuitive handling to a person skilled in the art so that he/she may get, without considerable extra effort and expense, to a diagnosis that is much more reliable with reference to the state of the art.

### DESCRIPTION OF THE INVENTION

The above mentioned task is resolved by the method of claim 1 and the image processing and reproduction system with the features of claim 18. Advantageous perfections are described in the dependent claims.

The method according to the invention for the pictorial representation of a three-dimensional measured data record representing, according to claim 1, a part of a hollow body comprises the following steps:

processing of a first subset of the three-dimensional measured data record for a (first) image reproduction in a first two-dimensional and/or three-dimensional intraluminal pictorial representation of an inner surface (structure) of the part of the hollow body;

processing of a second subset of the three-dimensional measured data record for a (second) image reproduction in a second two-dimensional and/or three-dimensional intraluminal pictorial representation of the part of the hollow body;

representation of the processed first subset of the three-dimensional measured data record in the form of the first two-dimensional and/or three-dimensional intraluminal pictorial representation in a representation plane; and

representation of the processed second subset of the three-dimensional measured data record in the form of the second two-dimensional and/or three-dimensional intraluminal pictorial representation in the same representation plane as the representation plane in which the first two-dimensional and three-dimensional intraluminal pictorial representation is realized,

wherein data of the processed second subset of the three-dimensional measured data record for one or several surfaces/planes in a predetermined distance perpendicular to the inner surface (structure) represented in the first two-dimensional and/or three-dimensional intraluminal pictorial representation is represented color-coded on the entire inner surface represented in the first two-dimensional and/or three-dimensional intraluminal pictorial representation.

Said three-dimensional measured data record may in particular represent a part of a human body which is being recorded with the help of a computer tomographic or nuclear spin tomographic device. This part of the human body may in particular be an organ, especially the intestine. Moreover, also lungs and bronchia as well as blood vessels in general may be representative for the three-dimensional data record.

First intraluminal view may correspond to the image of the surface structure of the interior of the hollow body obtained by means of a conventional (non-virtual) colonoscopy, for instance of a blood vessel or an intestinal tube. It is preferably represented monochromatically, whereas different levels of brightness may be provided for a three-dimensional impression. In the second two-dimensional and/or three-dimensional intraluminal pictorial representation, for instance, density values of the tissue that have been gathered for a predetermined distance from the surface of the surface structure represented in the first two-dimensional and/or three-dimensional intraluminal pictorial representation are represented (projected) color-coded on the surface of the surface structure.

In this way, in particular a projection of color-coded physical density values onto the surface (structure) shown in the first two-dimensional and/or three-dimensional intraluminal pictorial representation may be obtained in the second representation. In the second representation, initially the first representation may be shown (rendered), then the color-coded information can be projected (superimposed) onto the surface structure or the corresponding surface structure may be represented (rendered) directly in the same representation plane as in the first representation with the color coding of the second representation.

Although the present invention is being described especially with regard to virtual coloscopy, it shall be understood that the basic ideas of the invention are applicable to any desired three-dimensional data record. Possible other medical application fields are any kind of virtual endoscopy, other tomographic methods, ultrasound scan methods, X-ray scans with tracer substances, etc.

Further applications of the present invention are in the field of intestinoscopy, NHN endoscopy and ventricle endoscopy. Another particularly important application relates to virtual bronchoscopy. The recognition of lung carcinoma as well as of metastasis in lymph nodes may be improved on the basis of the method set forth in the present invention with reference to the state of the art.

The first and/or the second two-dimensional intraluminal pictorial representation/s may correspond to a projection of the inner surface onto one plane. In particular, the inner surface can be projected onto the faces of a cube or cylinder, especially if the faces of the cube or cylinder are subsequently imaged in one plane.

First and second two-dimensional and/or three-dimensional intraluminal pictorial representation/s may alternately or at the same time be displayed side by side on a display unit, e.g. a computer screen. Alternating display may be achieved in particular automatically in predetermined time intervals (for instance, apriori the first and after a few seconds the second representation may be displayed). This change between displays may also be repeated periodically. The change may be performed by a user (internist) with the help of a control device. Control means may comprise a computer mouse, in particular a scroll wheel and/or one or several button/s of a computer mouse, and/or a computer keyboard and/or a touch screen.

It is an essential feature of the present invention that the second two-dimensional and/or three-dimensional intraluminal pictorial representation comprising the color-coded processed measured values, e.g. of physical density, is provided quickly and easily, in addition to the topological first two-dimensional and/or three-dimensional intraluminal pictorial representation, if necessary alternating with the latter, and is provided especially for the entire part of the hollow body, e.g. an intestinal section, represented in the first two-dimensional and/or three-dimensional intraluminal pictorial representation.

In contrast, known state of the art only offers the possibility to mark a particular topologically suspicious area in a representation similar to the two-dimensional and/or three-dimensional intraluminal pictorial representation and then indicate color-coded information only for this area selected by the intervention of the user. Thus the state of the art leads necessarily to negative misdiagnosis, when for example polyps are hided behind folds in the intestine so that they cannot be perceived in the topological first two-dimensional and/or three-dimensional intraluminal pictorial representation.

Thus, in the state of the art, color-coded display of information takes only place and at the inducement of a user if there already is an (alleged) abnormality, whereas the method according to the invention facilitates the first detection of such an abnormality with the help of the second two-dimensional and/or three-dimensional intraluminal pictorial representation, i.e. in particular of the processed second subset of the three-dimensional measured data record.

The different above mentioned embodiments for an alternating display of the first and the second representation may be preselected particularly subsequent to a choice made by an operator. The change between displays allows just due to the different representations in comparison to each other a more reliable diagnosis and personal preferences for an automatical or manual switch (via a control means, e.g. a keyboard) are being taken into account. In case of an automatic switch between displayed representations, provision is also made for a preselection of duration of the corresponding display respectively of the period of the switch.

To ensure a quick display of the second three-dimensional intraluminal pictorial representation, it may be desirable to proceed to a surface rendering. Here, polygon sets may represent anatomical surfaces, whereas in the more complex volume rendering which is typically used in the state of the art, voxels from different surfaces/planes are used in parallel to the inner surface shown in the first representation for different image matrix dots, so that a real time representation of large areas (not only of small marked sectors of the first three-dimensional intraluminal pictorial representation) in the form of the second three-dimensional intraluminal pictorial representation is not possible nor practicable with the computer resources nowadays generally available. Moreover, a surface rendering does ensure, as the case may be, a higher sensitivity for detection of blood vessels, etc. To put it another way, the second two-dimensional and/or three-dimensional intraluminal pictorial representation may be grounded on a surface rendering method. In particular, the processed second subset may be imaged by a surface rendering method.

The use of physical density values as processed second subset of the three-dimensional measured data record for the second two-dimensional and/or three-dimensional intraluminal pictorial representation is particularly advantageous for diagnosis. Through this, polyps/tumors as well as blood vessels can be clearly recognized due to their compared to adjacent soft tissue. For instance, density values are represented being projected in a depth (distance from the inner surface shown in the first representation) of 2 or 3 mm onto the inner surface represented in the first representation.

According to a further development, data of the processed second subset of the three-dimensional data record represent color-coded average values of physical density values or temperature values for several surfaces in parallel to and in a predetermined distance from the surface represented in the first two-dimensional and/or three-dimensional intraluminal pictorial representation. For a corresponding point of the surface, density values are recorded for different depths and then averaged; the average values obtained for the points of the surface are then displayed in the second intraluminal pictorial representation on the inner surface in the same representation plane as in the first intraluminal pictorial representation. Averaging enables smoother color transitions and thus a better perceptibility of suspicious anatomic features respectively a smoothing of data “outliers”.

In particular, one or several pathological depths may be defined, a pathological depth defining a predetermined distance with reference to the inner surface shown in the first representation. Pathological depth(s) may be defined differently, depending on the procedure (for instance coloscopy, bronchoscopy, NHN endoscopy, ventricle endoscopy, etc.). A pathological depth may correspond to the distance between the elements of the second subset and the inner surface.

As an alternative or in addition to the above mentioned density color coding, the present invention provides a further kind of color-coded information display in intraluminal representations. Here, a depth color coding takes place for a fixed value or value range of a diagnostically significant measurand as for instance physical density or temperature. Thus according to depth color coding, for instance, a predetermined density value is represented in color on the surface structure of the first two-dimensional and/or three-dimensional intraluminal pictorial representation, the color providing information about the depth in which with reference to the surface of the surface structure tissues of the corresponding density or similar do occur. In other words, depth color coding may contain information about the depth with reference to the inner surface in which tissue with a density corresponding to the physical density range or to the individual predetermined density value occurs. In this way, in particular blood vessels may be easily detected which are indicating pathologically active areas (polyps, tumors). Moreover, a combination of density color coding and depth color coding may be advantageous for displaying different kinds of information at the same time. For instance, a high density close to the surface may be displayed in dark red and further away in bright red and a low density close to the surface in dark blue and further away in bright blue.

In particular, depth color coding as well as density color coding on a surface represented in the first intraluminal representation enables the detection of flat-growing, clinging tumors with for example thicknesses of 2 to 3 mm which are hardly or not detected at all even by conventional physical (non-virtual) endoscopy. Moreover, detection of hypervascularized tumors is much IS easier than before. Projection of density color coding in particular enables detection of polyps behind intestinal folds as well as of blood vessels behind intestinal mucosa which indicate a pathological hypervascularization of intestinal tissue/intestinal wall. Depth color coding especially enables visibility of lymph node metastasis behind bronchial walls. It should be noted that according to the method of the invention these color-coded representations are achieved in particular on an alternating basis with the first intraluminal representation and over the entire inner surface which is represented in the latter.

According to further examples of the present invention, at least one subset (which can be identical to the first or second) of the three-dimensional measured data record may be processed for an image reproduction in at least one more pictorial representation.

In particular, the user may be enabled to quickly display consecutively a couple of further pictorial representations, on the basis of the first pictorial representation, and thus to get a comprehensive overview of the corresponding represented region from several angles and viewing directions, thus reducing drastically the probability of overlooking a lesion for instance. Further pictorial representations may be represented in one and the same or in different representation planes, for instance at the same time with the two-dimensional and/or three-dimensional intraluminal pictorial representation, on the basis of the first and/or second and/or a third subset of the three-dimensional data record. In particular, further representations may show sections in the three-dimensional structure illustrated in the first/second representation. These sections may be selected by an operator by means of a control unit.

Within the framework of virtual coloscopy, two more representations may be displayed, one of which representing an “anterior wall view” and the other a “posterior wall view”, depending on whether it is an opposite or backward photograph of the intestinal wall. These images are obtained by virtually cutting open the intestinal tube in parallel to the longitudinal axis and taking the photographs with virtual cameras which are oriented vertically to the longitudinal axis (see also below).

The further pictorial representation may be a wall view of the hollow organ or of the blood vessel which is seen from a viewing direction which is in parallel or antiparallel to the vector of curvature at the maximum curvature of the central line of the hollow organ or the blood vessel. Starting from this (default-like) view, then the at least one further pictorial representation can be rotated as described above (for example by selection of an angle of rotation with the wheel of a computer mouse) to easily and quickly permit a complete overview of the region of interest.

As a rule, such a central line may be defined for a tubelike body even if the sections of the body deviate from the ideal circular form, calculation of the different points defining the central line corresponding to that of centers of gravity.

The central line mathematically represents a three-dimensional curve r(s) parameterized with the curve length s. At each point of the three-dimensional curve, the tangent unit vector indicates the direction of the curve in this point. Curvature vector points into the direction in which tangent unit vector changes (the vector of curvature thus is perpendicular to the tangent unit vector). The vector of curvature is calculated from the second derivation of the spatial curve in accordance with the curve length d² r(s)/ds² and its amount is referred to as curvature of the curve.

The “maximum curvature” can be an, in the mathematical sense, absolutely maximum curvature, but is as a rule the, in the mathematical sense, locally maximum curvature (local maximum), that means a site at which the vector of curvature is shorter than in the directly surrounding area.

Thanks to interaction between the different representations, complementary advantages of different representations can be utilized and thus the specific disadvantages of each special representation can be overcome.

In addition, the method may comprise the following steps:

Determination of a fourth subset of the three-dimensional measured data record according to a predetermined criterion,

processing of the fourth subset for an image reproduction or display in a two-dimensional and/or three-dimensional intraluminal pictorial representation of the part of the hollow body, and

representation of the processed fourth subset in the form of the two-dimensional and/or three-dimensional intraluminal pictorial representation, especially in the representation plane.

The determination of a fourth subset according to a predetermined criterion allows the gathering of additional information from the three-dimensional data record and their subsequent representation. In particular, the two-dimensional and/or three-dimensional intraluminal pictorial representation may correspond to the first and/or second two-dimensional and/or three-dimensional intraluminal pictorial representation or to a further two-dimensional and/or three-dimensional intraluminal pictorial representation which may be displayed in particular in turns with the first and/or second two-dimensional and/or three-dimensional intraluminal pictorial representation on the display unit, e.g. a computer screen, or simultaneously one besides the other.

A fourth subset may also in particular be determined if no third subset has been determined or processed. Determination of the fourth subset may be based on the entire three-dimensional measured data record or on a subset of the three-dimensional measured data record, in particular on the first subset.

Determination of the fourth subset may correspond to a computer aided diagnosis method (Computer Aided Diagnosis or Computer Aided Detection). Sensitivity of Computer Aided Diagnosis method is variably adjustable. The higher the sensitivity is, the more elements of the three-dimensional measured data record may meet the predetermined criterion.

Processing of the fourth subset may comprise a selection of a subquantity of the fourth subset according to an evaluation criterion, the evaluation criterion being based in particular on data of the three-dimensional measured data record for a sector of one or several planes in a predetermined distance perpendicularly to the inner surface.

In other words, evaluation criterion may be based on data, in particular measured data, of the second subset or the processed second subset.

By choosing a subquantity, the results of said computer aided diagnosis method may be selected or filtered. This is especially advantageous if a high sensitivity has been choosed for said computer aided diagnosis method. The elements of the subquantity may correspond to potential polyps or tumors.

The evaluation criterion may be based on a physical density value and/or a temperature value for an area or a part of a surface in parallel to the inner surface, whereas the area may correspond to the projection of the fourth subset onto the parallel surface.

The surface may in particular be part of a plane, the plane being parallel to the inner surface.

Physical density and/or temperature value may correspond to an average of physical density and/or temperature values for areas of several surfaces in parallel to the inner surface, whereas the areas may correspond to the projection of the fourth subset onto the parallel surfaces.

The predetermined distance of any of the one or several planes or surfaces may in particular correspond to a pathological depth.

Processing of the fourth subset may comprise a projection of the fourth subset onto the inner surface or onto one or several surfaces in parallel to the inner surface.

Projection may comprise a geometrical projection, in particular projection may correspond to a mapping of the fourth subset of the three-dimensional data record onto points of the inner surface or onto points of one or several surfaces in parallel to the inner surface. Projection may be equivalent to an orthogonal projection.

The fourth subset may comprise at least one coherent range, whereas in particular one parameter of all elements of each coherent range meets the predetermined criterion.

The parameter may in particular be equivalent to a measured value, in particular to a density or temperature value.

Coherent can in particular be referred to as spatially coherent. In other words, each coherent range may comprise a subset of the three-dimensional measured data record, each element of the subset or of the range corresponding to a tuple of parameters and/or measured values and each tuple comprising information relating to the spatial arrangement of the element. Spatial information may be defined explicitly, in particular by coordinates, or implicitly, in particular by an arrangement of the measured values in the three-dimensional measured data record.

Display of the fourth subset may comprise a marking, in particular a symbolic marking. In particular, projection onto the inner surface may be marked. When doing so, marking of projection of each coherent range onto the inner surface or of only coherent ranges of the selected subquantity of the fourth subset is possible. A marking based on a coherent range of the selected subquantity may be different, especially as to the form and/or the color, from a marking based on a coherent range, which is not an element of the selected subquantity.

As an alternative or in addition, the fourth subset, especially the selected subquantity, may be represented pictorially. As an example, a “voxel rendering” method or a “surface rendering” method may be used for representation. In particular, representation of the inner surface may be provided with a transparency. In this way, parts of the fourth subset which are situated under the inner surface, may be visualized. In particular, representation of a coherent range of the selected subquantity may be different, especially as to form and/or color, from the representation of a coherent range, which is not an element of the selected subquantity.

The method may furthermore comprise:

the determination of a characteristic point for at least one coherent range of the fourth subset, and

the projection of only the characteristic point onto the inner surface or onto one or several surfaces in parallel to the inner surface.

The characteristic point may correlate with the center of gravity, in particular the geometrical center of gravity, of the coherent range. The characteristic point may correlate with the element featuring the smallest normal distance from the inner surface.

Image reproduction or display may be based on the entire fourth subset or only on the selected subquantity. In particular image reproduction or display may only comprise coherent ranges which are an element of the selected subquantity, or all coherent ranges of the fourth subset.

Image reproduction or display may be based on the entire fourth subset, but the configuration of image reproduction or display of the selected subquantity may be different from image reproduction or display of the non-selected subquantity.

Predetermined criterion may comprise a density and/or form criterion.

For any element of the measured data record, the measured data record may comprise in particular parameters for the site and measured values for the intensity of the signal. The intensity of the signal at one site may me proportional to a local physical density at this site. An intensity of the signal may correlate with a gray value or a color value. The intensity of the signal may be displayed as gray value or color value.

By way of example, a form criterion may comprise a parameter of curvature, a proportion of spatial extensions in different directions, a maximum and/or minimum spatial extension and/or a maximum and/or minimal ellipticity. In particular, determination of the fourth subset may comprise a pattern analysis. A pattern may be defined as intensity repartition. Intensity repartition may be two-dimensional or three-dimensional. Determination of the fourth subset may comprise a search for a predetermined pattern in the three-dimensional measured data record or in a subset of the three-dimensional measured data record.

Density criterion may comprise a predetermined density value, in particular a maximum, minimum or average density value and/or a predetermined density range, the density parameter or the measured density value of each element of a coherent range of the fourth subset exhibiting in particular a density value lying over or under the predetermined density value or a density value which is in the predetermined density range.

If signal intensity is proportional to a physical density, a form criterion may be equivalent to a density criterion. In this case, a predetermined repartition of intensity is equivalent to a predetermined repartition of density.

The predetermined criterion may in particular comprise a minimum spatial extension for a coherent range. The smaller selection of this minimum spatial extension is, the more numerous usually coherent ranges to be determined are,

The above mentioned methods may in particular be computer aided.

The present invention also provides a method for computer implemented examination of a hollow body, in particular a hollow organ, comprising the following steps:

receiving of a three-dimensional measured data record, the three-dimensional measured data record representing at least a part of the hollow body,

determination of an inner surface of the hollow body or the part of the hollow body,

determination of a fourth subset of the three-dimensional measured data record according to a predetermined criterion, and

processing of the fourth subset based on an evaluation criterion, the evaluation criterion being based in particular on data of the three-dimensional measured data record for an area of one or several planes in a predetermined distance perpendicularly to the inner surface.

The inner surface of the hollow body may in particular comprise elements of the first subset.

Processing of the fourth subset may comprise a selection of a subquantity of the fourth subset according to the evaluation criterion.

Evaluation criterion may be based on a physical density value and/or a temperature value for an area or part of a surface in parallel to the inner surface and the area may correspond to the projection of the fourth subset onto the parallel surface.

Physical density value and/or temperature value may correspond to an average value of physical density values and/or temperature values for areas of several surfaces in parallel to the inner surface, whereas the areas may correspond to the projection of the fourth subset onto the parallel surfaces.

Processing of the fourth subset may comprise a projection of the fourth subset onto the inner surface or onto one or several surfaces in parallel to the inner surface.

Projection may comprise a geometrical projection, in particular projection may be equivalent to a mapping of the fourth subset of the three-dimensional data record onto points of the inner surface or onto points of one or several surfaces in parallel to the inner surface.

The projection may be equivalent to an orthogonal projection.

Fourth subset may comprise at least one coherent range. in particular one parameter of all elements of each coherent range meeting the predetermined criterion.

The method for computer implemented examination of a hollow body may furthermore comprise the following steps:

determination of a characteristic point for at least one coherent range of the fourth subset, and

projection of only the characteristic point onto the inner surface or onto one or several surfaces in parallel to the inner surface.

The method for computer implemented examination of a hollow body may furthermore comprise the following steps:

processing of the fourth subset for an image reproduction or display in a two-dimensional and/or three-dimensional intraluminal pictorial representation of the part of the hollow body, and

representation of the processed fourth subset in the form of the two-dimensional and/or three-dimensional intraluminal pictorial representation, especially in the representation plane.

Image reproduction or display may be based on the entire fourth subset or only on the selected subquantity.

Image reproduction or display may be based on the entire fourth subset, however, configuration of image reproduction or display of the selected subquantity may be different from image reproduction or display of the non-selected subquantity.

In particular, image reproduction or display of the fourth subset may be of the above depicted form.

The step of representation of the processed fourth subset may comprise a pictorial representation, in particular simultaneous or in turns, of the three-dimensional measured data record according to a method described above.

The present invention also provides a computer program product which comprises one or several computer-readable media (data carriers) with instructions to be carried out by the computer for carrying out the steps of one of the methods described above.

The above mentioned object underlying the invention is further solved by an image processing and image reproduction system for carrying out one of the above mentioned examples of the method according to the invention, comprising:

an image processing and reproduction system for carrying out an above mentioned method, comprising:

a device suited for

processing of a first subset of a three-dimensional measured data record that represents a part of the hollow body, for a first image reproduction in a first three-dimensional intraluminal pictorial representation of an inner surface of the part of the hollow body; and

processing of a second subset of the three-dimensional measured data record for a second pictorial reproduction in a second three-dimensional intraluminal pictorial representation of the part of the hollow body;

a display unit suited for the display of the first and second three-dimensional intraluminal pictorial representation of the part of the hollow body,

and/or

a device suited for

determination of a fourth subset of the three-dimensional measured data record according to a predetermined criterion, and

processing of the fourth subset based on an evaluation criterion, the evaluation criterion being in particular based on data of the three-dimensional measured data record for a part of one or several planes in a predetermined distance perpendicularly to the inner surface.

The image processing and reproduction system may further comprise a computer tomographic or nuclear spin tomographic device for creating the three-dimensional measured data record and a storing device for the storage of at least a part of the three-dimensional measured data record. Equally, an image processing and reproduction system as mentioned above is provided, comprising a computer program product as mentioned above and a reading unit therefore.

Below, further details of embodiments of the invention are further illustrated with reference to the attached figures. The described embodiments are in every respect only to be considered as illustrative and not as restrictive, and various combinations of the stated features are included in the invention.

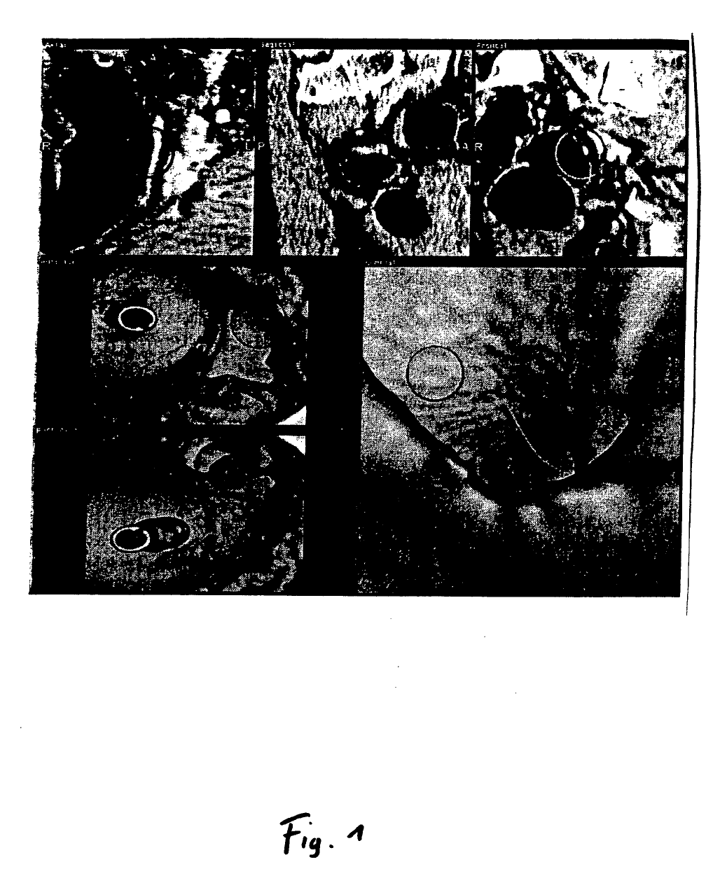

FIG. 1 shows useful views of virtual coloscopy which are simultaneously presented to a user.

FIG. 1 shows virtual intestine views. Upper row of FIG. 1 shows two-dimensional views, from left to right in the following sequence, an axial view corresponding to a section perpendicular to the longitudinal axis of the intestine, a side view or sagital view and a frontal view. The intersecting planes of the three tomograms are perpendicular to one another. The two-dimensional tomograms are calculated from the three-dimensional measured data record created with the aid of a computer tomograph which in turn has been created from a plurality of two-dimensional measured data records.

Representations at the bottom left are referred to as “wall views”. These images are obtained by virtually cutting open the intestinal tube in parallel to the longitudinal axis and taking the photographs with virtual cameras which are oriented vertically to the longitudinal axis. A difference is made between “anterior wall view” and “posterior wall view” and depending on whether it is an opposite or backward photograph of the intestinal wall.

The pictorial representation at the bottom right is a three-dimensional intraluminal view giving to the internist a spatial idea of the region to be examinated or treated. This intraluminal view corresponds to the image obtained with a conventional colonoscopy of the interior of the intestinal tube, i.e. of the inner surface (structure) of the intestinal section, with the difference that it has been virtually created. The surface structure is represented as a monochrome image and different brightness levels make the three-dimensional impression. Such views are well known in the state of the art. The internist inspects the intestinal tube along the intestine with the help of the intraluminal view (on-flight). In case of detection of any real or apparent abnormality, the internist may mark the corresponding site and then proceed to displaying new sectional views and more, for instance color-coded, information in two-dimensional or three-dimensional views for the marked region. However, this conventional method has the major disadvantage that only if the internist detects a suspicious site in the intraluminal view he will proceed to further diagnostic steps. Yet, in case a polyp is hided behind an intestinal fold, the internist will not detect it under the current state of the art and make a false diagnosis as a consequence.

This is where the present invention has a great advantage. In fact, the invention provides, by default, an additional intraluminal view in which processed measured data which are of high relevance for the diagnosis, in particular physical density values, are represented color-coded (e.g. projected) on the surface structure conventionnally represented in virtual endoscopy, and this in particular for the entire region of the intestinal section shown in FIG. 1. These processed measured data are those that have been gathered for one or several surfaces/planes in a predetermined distance under the surface structure shown in FIG. 1 in the intraluminal view. In so doing, for instance, values of physical density are projected color-coded onto the represented surface in a distance of 2 mm beneath the latter. The user may, for instance by key input or mouse click, switch between the intraluminal image shown in FIG. 1 and the image featuring the color-coded processed measured data. Such a switch between images may also take place automatically within determined time intervals or each time after a modification of the represented image by virtual movement along the intestine. Both kinds of intraluminal views may be simultaneously displayed in different windows, too.

As this switching between intraluminal views respectively their simultaneous display is executed regardless of whether an abnormality is detected in the monochrome surface structure representation or not, the risk of overlooking a polyp or similar behind an intestinal fold is extremely reduced. Such a polyp may easily be detected, with the method according to the invention, in the color-coded view which covers, as said above, the whole range of the monochrome image, by its increased density (e.g. red coded, as opposed to blue coded hollow spaces). The intraluminal view provided by default according to the invention comprising said color-coded density values from deeper planes compared to the monochrome representation of surface structure in parallel to the surface thus serves as primary detection aid, a feature that representations cannot meet with the help of color-coded density values, as these are always provided only for previously identified and marked limited sub-sections of topologically represented surface structures.

In the method according to the invention, an internist thus is enabled to switch on-flight (virtual flight of the camera through and along the intestine) between representations of the inner surface of the intestine and information—such as in form of density values—about levels beneath said represented surface of the intestine respectively to check these at the same time, whereby he/she may reliably detect the existence of correlations between surface texture and depth structure. For instance, he/she would be able to easily recognize, in the topologically entirely unsuspicious section indicated by the circle of the intraluminal view of FIG. 1, in the intraluminal view provided according to the invention in addition or in turns, either automatically or at the touch of a button, etc., thanks to the color-coded density values projected onto the surface structure, more or less pronounced blood vessels indicating polyps or tumors. It should be noted that color-coded represented density values may be values averaged over several planes to obtain smoother color transitions. Thus, for instance, a color-coded value may be obtained at a site from an averaging of the physical density along a normal vector to the surface in distances of 2.8, 2.9, 3.1 and 3.2 mm from the surface.

As an alternative or in addition to the above mentioned density color coding for deeper situated planes, the present invention provides a further kind of color coded information display in intraluminal representations. In this connection, a depth color coding is performed for a fixed value range, for instance a fixed value, a diagnostically significant measurand as for instance physical density. A region of increased density close to the intraluminal view of surface structure shown in FIG. 1 may for example be marked in red and a region which is relatively far away (at a deeper level) may be marked in blue. This enables an easy recognition of the extension of an abnormality of increased density in particular perpendicularly to the surface normal of the surface. Such an information, for instance, is of great value for an endobronchial biopsis of lymph node metastasis. Value range may be selected for instance by means of a displayed slider bar, for example with the help of a computer mouse.

Moreover, in the method according to the invention, potentially pathological areas may be determined according to a predetermined criterion. This may be achieved with the help of a computer aided diagnosis (CAD) method (cf. e.g. Hiroyuki Yoshida and Janne Näppi, “Three-Dimensional Computer-Aided Diagnosis Scheme for Detection of Colonic Polyps”, IEEE TRANSACTIONS ON MEDICAL IMAGING, Vol. 20, No. 12, December 2001). CAD methods frequently are algorithms for form analysis, but may equally comprise other algorithms for automatic detection of potentially pathological areas. A high setting of the sensitivity of the CAD method may be choosed so that many potentially pathological areas may be detected. In this case, the number of found potentially pathological areas may be too high, however. For each of these potentially pathological areas one may then determine a relevance according to an evaluation criterion. Thus, only those potentially pathological areas may be indicated to the doctor which meet with the evaluation criterion. As an alternative, potentially pathological areas meeting with evaluation criterion may be represented in a different representation form, for instance with a different color coding.

In particular, the area of the inner surface corresponding to a projection of the potentially pathological area onto the inner surface may be marked in an intraluminal view. For instance, a circle may used to mark the area of the inner surface which corresponds to the projection of a potentially pathological area onto the inner surface. As a marker, also a pointer symbol such as an arrow symbol may be used.

The color of encircling and/or of the arrow symbol may be based on the relevance of the potentially pathological region. For instance, encircling and/or arrow symbol may be marked in red if the potentially pathological region meets the evaluation criterion, and in blue if the evaluation criterion is not met.

Especially advantageous for the diagnosis is the use of physical density values for selection of the potentially pathological areas on the basis of the evaluation criterion. Through this, polyps/tumors as well as blood vessels can be clearly recognized due to their compared to adjacent soft tissue. For instance, density values in a depth (distance from the inner surface shown in the first representation) of 2 or 3 mm are used for the evaluation criterion. For instance, a potentially pathological area may be considered as relevant if the density value in a section of a plane in a depth of e.g. 2 or 3 mm with regard to the inner surface, which corresponds to a projection of the potentially pathological region onto this plane, exceeds a critical value and/or is in a predetermined density range.

For the evaluation criterion, it is also possible to use several planes in different depths compared to the inner surface. Thus, for instance, the evaluation criterion may be obtained by an averaging of the physical density along a normal vector to the surface, in particular in distances of 2.8, 2.9, 3.1 and 3.2 mm from the surface.

The selection of potentially pathological areas facilitates a combination of the advantages of CAD methods and the advantages of depth information, i.e. information about tissue properties in a predetermined depth with reference to an inner surface. In particular CAD methods are suited to provide even the merest suspicious forms which then will be checked, on the basis of depth information, for relevance, e.g. for soft tissue association. This enables a rapid automatical detection via CAD in case of high true positive probability.

In particular, a computer-implemented method for examination of a hollow body may receive measured data, for instance computer tomographic or nucelar spin tomographic data. These measured data may then be segmented for determination of an inner surface. Determination of the surface may be achieved by means of a known method. Moreover, from the three-dimensional measured data record, structures, i.e. coherent ranges, may be selected which meet a predetermined criterion. These structures may correspond to potentially pathological regions. The relevance of these structures may be determined with the help of an evaluation criterion.

1. Method for the pictorial representation of a three-dimensional measured data record representing part of a hollow body, comprising the following steps:
processing of a first subset of the three-dimensional measured data record for an image reproduction in a first two-dimensional and/or three-dimensional intraluminal pictorial representation of an inner surface of the part of the hollow body,
processing of a second subset of the three-dimensional measured data record for an image reproduction in a second two-dimensional and/or three-dimensional intraluminal pictorial representation of the part of the hollow body,
representation of the processed first subset of the three-dimensional measured data record in the form of the first two-dimensional and/or three-dimensional intraluminal pictorial representation in a representation plane; and
representation of the processed second subset of the three-dimensional measured data record in the form of the second two-dimensional and/or three-dimensional intraluminal pictorial representation in the representation plane,
wherein data of the processed second subset of the three-dimensional measured data record for one or several planes in a predetermined distance perpendicular to the surface structure represented in the first two-dimensional and/or three-dimensional intraluminal pictorial representation are represented color-coded on the surface structure of the inside of the hollow body, which is represented in the entire first two-dimensional and/or three-dimensional intraluminal pictorial representation.

2. The method according to claim 1, comprising simultaneous display of the first and second two-dimensional and/or three-dimensional intraluminal pictorial representation within two different windows on a display unit, in particular on a computer screen.

3. The method according to claim 1, comprising alternating display of the first and second two-dimensional and/or three-dimensional intraluminal pictorial representation within one window on a display unit, in particular on a computer screen.

4. The method according to claim 3, wherein switching of display from the first to the second two-dimensional and/or three-dimensional intraluminal pictorial representation or vice versa takes place automatically after a predetermined period.

5. The method according to claim 4, wherein switching of display from the first to the second two-dimensional and/or three-dimensional intraluminal pictorial representation is repeatedly achieved for a predetermined period.

6. The method according to claim 3, wherein switching of display from the first to the second two-dimensional and/or three-dimensional intraluminal pictorial representation or vice versa is achieved in answer to a manual input, in particular by means of a keyboard or a computer mouse.

7. The method according to claim 1, wherein the data of the processed second subset of the three-dimensional measured data record represent color-coded physical density values or temperature values for a surface in parallel to and in a predetermined distance from the surface represented in the first two-dimensional and/or three-dimensional intraluminal pictorial representation.

8. The method according to claim 1, wherein the data of the processed second subset of the three-dimensional measured data record represent color-coded average values of physical density values or temperature values for several surfaces in parallel to and in a predetermined distance from the surface represented in the first two-dimensional and/or three-dimensional intraluminal pictorial representation.

9. The method according to claim 1, wherein the data of the processed second subset of the three-dimensional measured data record represent a physical density range or a single predetermined density value in depth color coding, depth color coding containing in particular information about in which depth with reference to the inner surface there is tissue with a density corresponding to the physical density range or to the single predetermined density value.

10. The method according to claim 1, wherein the data of the processed second subset of the three-dimensional measured data record represent a physical density range, a surface rendering method being used for representation of the second two-dimensional and/or three-dimensional intraluminal pictorial representation.

11. The method according to claim 1, comprising moreover the representation of at least one more pictorial representation of the processed first and/or second subset and/or a third subset of the three-dimensional measured data record.

12. The method according to claim 11, wherein the at least one more pictorial representation of the processed first and/or second subset and/or a third subset of the three-dimensional measured data record comprises a two-dimensional representation or a combination of a three-dimensional and a two-dimensional representation.

13. The method according to claim 12, wherein the at least one more pictorial representation is a section view, in particular an axial view and/or a front view and/or a sagital view and/or an oblique view.

14. The method according to claim 1, wherein the three-dimensional measured data record comprises computer tomographic or nuclear spin tomographic image data of at least a part of a hollow body of a human or animal body, in particular a part of an organ or of a blood vessel.

15. The method according to claim 1 for the use in virtual endoscopy, in particular virtual coloscopy or virtual bronchoscopy.

16. The method according to claim 1, comprising:
determination of a fourth subset of the three-dimensional measured data record according to a predetermined criterion;
processing of the fourth subset for an image reproduction or display in a two-dimensional and/or three-dimensional intraluminal pictorial representation of the part of the hollow body; and
representation of the processed fourth subset in the form of the two-dimensional and/or three-dimensional intraluminal pictorial representation, in particular in the representation plane.

17. The method of claim 16, wherein processing of the fourth subset comprises a selection of a subquantity of the fourth subset according to an evaluation criterion, in particular the evaluation criterion being based on data of the three-dimensional measured data record for a part of one or several planes in a predetermined distance vertically to the inner surface.

18. The method of claim 17, wherein the evaluation criterion is based on a physical density value and/or a temperature value for a section of a surface in parallel to the inner surface, the section corresponding to the projection of the fourth subset onto the parallel surface.

19. The method of claim 18, wherein the physical density value and/or temperature value correspond to an average of physical density and/or temperature values for sections of several surfaces in parallel to the inner surface, the sections corresponding to the projection of the fourth subset onto the parallel surfaces.

20. The method according to claim 16, processing of the fourth subset comprising a projection of the fourth subset onto the inner surface or onto one or several surfaces in parallel to the inner surface.

21. The method according to claim 20, wherein the projection comprises a geometrical projection, in particular projection may correspond to a mapping of the fourth subset of the three-dimensional data record onto points of the inner surface or onto points of one or several surfaces in parallel to the inner surface.

22. The method according to claim 20, wherein the projection is equivalent to an orthogonal projection.

23. The method according to claim 16, wherein the fourth subset comprises at least one coherent range, in particular one parameter of all elements of each coherent range meeting the predetermined criterion.

24. The method of claim 23, comprising:
determination of a characteristic point for at least one coherent range of the fourth subset; and
projection of only the characteristic point onto the inner surface or onto one or several surfaces in parallel to the inner surface.

25. The method according to claim 17, wherein image reproduction or display is based on the entire fourth subset or only on the selected subquantity.

26. The method according to claim 25, wherein image reproduction or display is based on the entire fourth subset, configuration of image reproduction or display of the selected subquantity being different from the image reproduction or display of the non-selected subquantity.

27. The method according to claim 16, wherein the predetermined criterion may comprise a density criterion and/or a form criterion.

28. The method according to claim 27, wherein the density criterion comprises a predetermined density value, in particular a maximum or minimum density value or a predetermined density range, in particular the density parameter of each element of a coherent range of the fourth subset exhibiting a density value above or below the predetermined density value or a density value included in the predetermined density range.

29. Method for computer implemented examination of a hollow body, in particular a hollow organ, comprising the following steps:
receiving of a three-dimensional measured data record, the three-dimensional measured data record representing at least a part of the hollow body,
determination of an inner surface of the hollow body or the part of the hollow body;
determination of a fourth subset of the three-dimensional measured data record according to a predetermined criterion; and
processing of the fourth subset based on an evaluation criterion, in particular the evaluation criterion being based on data of the three-dimensional measured data record for a section of one or several planes in a predetermined distance perpendicularly to the inner surface.

30. The method according to claim 29, wherein processing of the fourth subset comprises a selection of a subquantity of the fourth subset according to the evaluation criterion.

31. The method according to claim 29, wherein the evaluation criterion is based on a physical density value and/or a temperature value for a section of a surface in parallel to the inner surface, the section corresponding to the projection of the fourth subset onto the parallel surface.

32. The method according to claim 31, wherein the physical density value and/or temperature value correspond to an average of physical density values and/or temperature values for sections of a number of surfaces in parallel to the inner surface, the sections corresponding to the projection of the fourth subset onto the parallel surfaces.

33. The method according to claim 29, wherein processing of the fourth subset comprises a projection of the fourth subset onto the inner surface or onto one or several surfaces in parallel to the inner surface.

34. The method according to claim 33, wherein projection comprises a geometrical projection, in particular projection corresponding to a mapping of the fourth subset of the three-dimensional data record onto points of the inner surface or onto points of one or several surfaces in parallel to the inner surface.

35. The method according to claim 33, wherein projection is equivalent to an orthogonal projection.

36. The method according to claim 29, wherein the fourth subset comprises at least one coherent range, in particular one parameter of all elements of each coherent range meeting the predetermined criterion.

37. The method of claim 36, comprising:
determination of a characteristic point for at least one coherent range of the fourth subset; and
projection of only the characteristic point onto the inner surface or onto one or several surfaces in parallel to the inner surface.

38. The method according to claim 29, comprising:
processing of the fourth subset for an image reproduction or display in a two-dimensional and/or three-dimensional intraluminal pictorial representation of the part of the hollow body; and
representation of the processed fourth subset in the form of the two-dimensional and/or three-dimensional intraluminal pictorial representation, in particular in the representation plane.

39. The method according to claim 38, wherein image reproduction or display is based on the entire fourth subset or only on the selected subquantity.

40. The method according to claim 39, wherein image reproduction or display is based on the entire fourth subset, configuration of image reproduction or display of the selected subquantity being different from the image reproduction or display of the non-selected subquantity.

41. The method according to claim 38, comprising a, in particular simultaneous, pictorial representation of the three-dimensional measured data record according to a method according to the following steps:
processing of a first subset of the three-dimensional measured data record for an image reproduction in a first two-dimensional and/or three-dimensional intraluminal pictorial representation of an inner surface of the part of the hollow body,
processing of a second subset of the three-dimensional measured data record for an image reproduction in a second two-dimensional and/or three-dimensional intraluminal pictorial representation of the part of the hollow body,
representation of the processed first subset of the three-dimensional measured data record in the form of the first two-dimensional and/or three-dimensional intraluminal pictorial representation in a representation plane; and
representation of the processed second subset of the three-dimensional measured data record in the form of the second two-dimensional and/or three-dimensional intraluminal pictorial representation in the representation plane,
wherein data of the processed second subset of the three-dimensional measured data record for one or several planes in a predetermined distance perpendicular to the surface structure represented in the first two-dimensional and/or three-dimensional intraluminal pictorial representation are represented color-coded on the surface structure of the inside of the hollow body. which is represented in the entire first two-dimensional and/or three-dimensional intraluminal pictorial representation.

42. A computer program product comprising one or several computer-readable media with instructions executable by the computer for execution of the steps of a method according to claim 1.

43. An image processing and reproduction system for implementation of a method according to claim 1, comprising:
a means that is suitable for
processing of a first subset of a three-dimensional measured data record representing a part of a hollow body, for a first image reproduction in a first three-dimensional intraluminal pictorial representation of an inner surface of the part of the hollow body; and
processing of a second subset of the three-dimensional measured data record for a second image reproduction in a second three-dimensional intraluminal pictorial representation of the part of the hollow body;
a display unit suited for displaying the first and second three-dimensional intraluminal pictorial representation of the part of the hollow body; and/or
a means that is suitable for
the determination of a fourth subset of the three-dimensional measured data record according to a predetermined criterion; and
processing of the fourth subset based on an evaluation criterion, in particular the evaluation criterion being based on data of the three-dimensional measured data record for a part of one or several planes in a predetermined distance perpendicularly to the inner surface.

44. The image processing and reproduction system of claim 43, further comprising a computer tomographic or nuclear spin tomographic system for creation of the three-dimensional measured data record.
